(19) United States
(12) Patent Application Publication
(10) Pub. No.: US 2016/0327085 A1
(43) Pub. Date: Nov. 10, 2016

(54) 180°-Hinge

(71) Applicant: Pöttker GmbH, Lippstadt (DE)

(72) Inventor: Daniel Carrera Gonzalez, Lippstadt (DE)

(21) Appl. No.: 15/143,880

(22) Filed: May 2, 2016

(30) Foreign Application Priority Data
May 4, 2015 (DE) 202015102263.8

(51) Int. Cl. F16C 11/04; A47B 96/00

(52) U.S. Cl. CPC F16C 11/04; A47B 96/00; A47B 2220/0072

(57) ABSTRACT

A 180°-hinge for plate-shaped furniture parts (12), includes two mirror-symmetric extruded profiles (14) each of which forms an L- or U-shaped seat for an edge of one of the furniture parts (12) and, on the side opposite to the seat (16), a projecting profile portion (20) which is interrupted by cutouts (22) and in which a passage for a continuous hinge axle (24) is formed, and connection profiles (26) which engage in the cutouts (22) and each of which forms two parallel passages (24′) for the hinge axles (24) and is pivotable relative to each of the extruded profiles (14) by an angle of at least 90° about the corresponding hinge axle.

The invention relates to a 180°-hinge for plate shaped furniture parts.

For furniture, hinges, e.g. in the form of piano hinges, are known which can be fixed at the furniture parts by means of screws and permit to pivot the furniture parts from a position in which they are arranged in a common plane about an angle of 180° into a position in which they lie flat one upon the other.

It is an object of the invention to provide a hinge of this type which is inconspicuous, especially in the position in which the furniture parts lie in a common plane, and which projects as little as possible beyond the surface of the furniture parts.

According to the invention, this object is achieved by two mirror-symmetric extrude profiles each of which forms an L- or U-shaped seat for an edge of one of the furniture parts and has, on the side opposite to the seat, a projecting profile portion which is interrupted by cutouts and in which a passage for a continuous hinge axle is formed, and by connection profiles which engage in the cutouts and each form two parallel passages for the hinge axles and are pivotable relative to each extruded profile by an angle of at last 90° about to the corresponding hinge axle.

The hinge may be produced at low costs from extruded material and permits, thanks to the L- or U-shaped seats, a stable and yet inconspicuous fixation at the furniture parts. In the position in which the furniture parts lie in a common plane, the connection profiles can largely be embedded in the cutouts, so that they do not or hardly project beyond the surface of the furniture parts. When the two furniture parts are folded one upon the other, the connection profiles pivot about an angle of only 90° relative to each furniture part, which results, for the pivotal movements about both hinge axles together, in a pivot angle of 180°.

Useful details of the invention are indicated in the dependent claims.

If the seats for the edges of the furniture parts are U-shaped, it is preferred that one leg is considerably longer than the other leg that is parallel thereto. The plate shaped furniture part can then be fixed at the longer leg by means of screws or adhesive, e.g. by means of a double-sided adhesive tape, whereas the shorter leg barely girds the edge of the furniture part and serves only to form a counter bearing for the furniture part so that the latter can smoothly be pivoted into its seat and glued to the longer leg, with the shorter leg, which is on the visible side of the furniture parts when the furniture is used, being relatively inconspicuous.

In an advantageous embodiment, the connection profiles provide stops which limit the pivotal range of each extruded profile to 90°.

An embodiment example will now be described in greater detail in conjunction with the drawings, wherein:

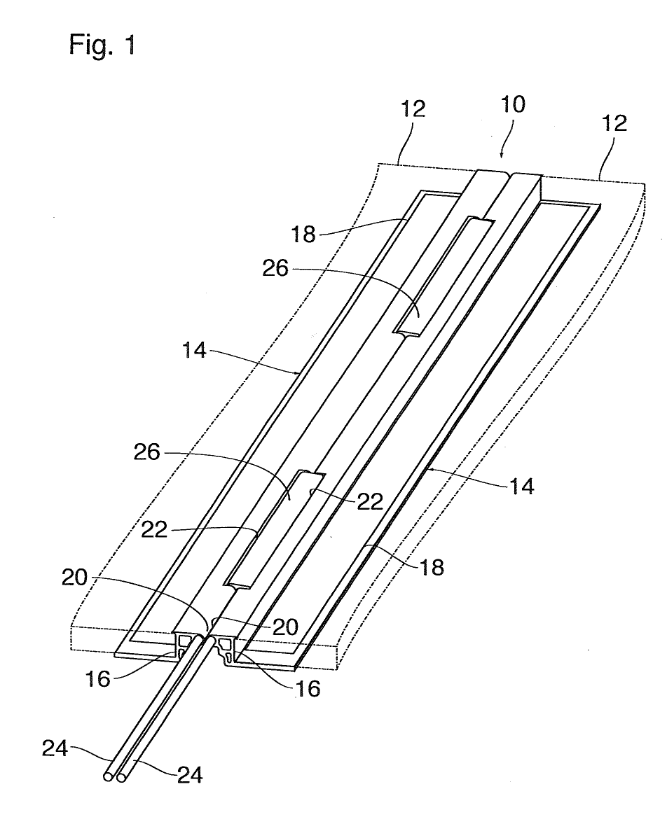

FIG. 1 is a perspective view of a portion of a hinge according to the invention;

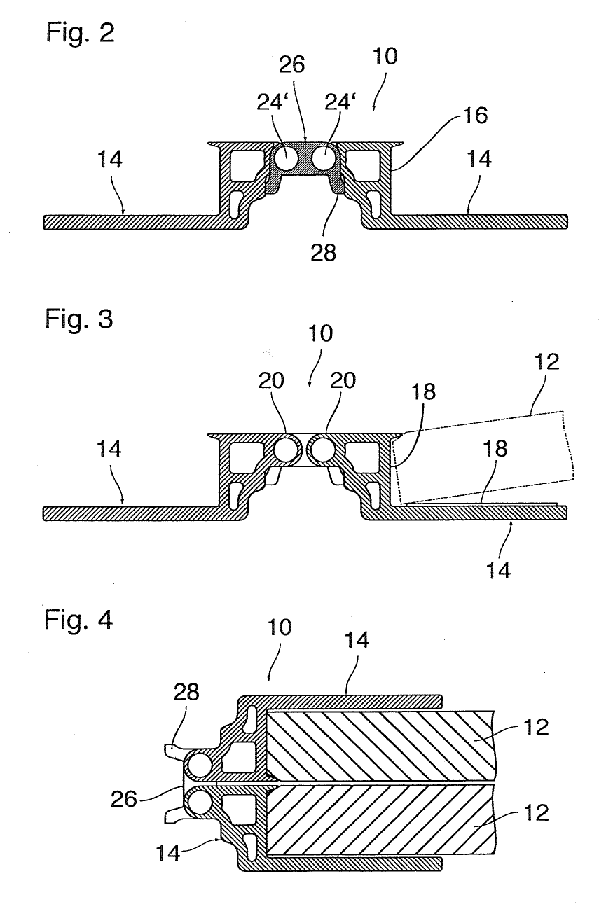

FIG. 2 is a cross section of the hinge in a 180° folded-open position;

FIG. 3 is a cross section of the hinge in a different sectional plane; and

FIG. 4 is a cross section of the hinge and two plates held in the hinge in a position in which the plates are folded over so that they lie flat one upon the other.

FIG. 1 shows a hinge 10 which girds the parallel edges of two plates 12 of equal thickness which, in FIG. 1, in which the hinge 10 is stretched or folded open, lie in a common plane. The plates 12 may for example be parts of a tabletop or worktop, such as parts of a so-called folding type inlay plate which can be stowed underneath a continuous tabletop or worktop of furniture in a position in which the two plates are folded one upon the other. The plates 12 may for example be made of glass or derived timber product.

The hinge 10 has two extruded profiles 14 arranged mirror-symmetric relative to one another, which are formed for example of extruded aluminum or light metal and each of which forms a U-shaped seat 16 for the edge of one of the plates 12. In the example shown, the upper leg of each seat 16 is reduced in length in comparison to the lower leg such that the extruded profile as a whole has an almost L-shaped configuration. Each of the plates 12 is fixed at the longer leg of the seat by means of a double-sided adhesive tape 18.

On the side opposite to the seat 16, each of the extruded profiles 14 has a profile portion 20 which is flush with the outer surface of the shorter leg of the seat 16 and projects towards the respective other one of the extruded profiles. These profile portions 20 are interrupted in certain intervals in longitudinal direction of the hinge by cutouts 22 and each form a passage with circular cross-section through which a hinge axle 24 in the form of a cylindrical bar may be inserted. Each pair of mutually opposite cutouts 22 of the two extruded profiles, together, form a rectangular recess in which a connection profile 26 is received which fills the recess almost completely. Each connection profile 26 has two parallel passages 24′ (FIG. 2) through which the hinge axles 24 may be passed through, so that the extruded profiles 14 and the connection profiles 26 are articulated to one another by the continuous hinge axles 24.

FIG. 2 shows the hinge 10 in a cross-sectional view at a position of one of the connection profiles 26. In the connection profile, the above-mentioned passages 24′ for the hinge axles are visible. The top side of the connection profile 26 is flush with the top side of the shorter leg of the seat 16. In contrast, at the bottom side of the connection profile 26, two outwardly cranked ribs 28 are formed which engage corresponding ledges of the extruded profiles 14 and thereby prevent the extruded profiles 14 from being pivoted downwards relative to the connection profiles 26 beyond the position shown in FIG. 2.

The profile portions of the extruded profiles 14 which form the base of the respective seat 16 are configured as hollow profiles in this example.

FIG. 3 shows a cross-sectional view of the hinge 10 at a position at which the projecting profile portions 20 are formed. For the extruded profile 14 on the right side in FIG. 3 the double-sided adhesive tape 18 is also shown, and the cross-section of the edge of the plate 12 has been indicated in dashed lines. In order to fix the plate 12 safely and stably in the seat 16 by means of the adhesive tape, the plate is at first held in a slightly slanting position and is hooked-in with its upper edge under the shorter leg of the seat. Subsequently, the plate is pivoted against the lower leg of the seat until its bottom side comes into contact with the adhesive tape 18 and is pressed against the tape with leverage.

Relative to the connection profile 26, each of the two extruded profiles 14 is pivotable by 90° about the corresponding hinge axle 24.

FIG. 4 shows the hinge 10 in a position folded-over by 180°, in which position the two plates 12 are flatly superposed one upon the other. Relative to the lower extruded profile 14, the connection profiles 26 have been pivoted by an angle of 90° upwards in FIG. 4, and the top extruded profile has again been pivoted by 90° relative to the connection profiles 26. The pivotal range is limited because the outer surfaces of the shorter legs of the seats 16 and the projecting profile portions 20 which, in FIGS. 2 and 3, form the top sides of the extruded profiles are in abutment with one another, while the extruded profiles and the connection profiles 26 are held together by the hinge axles 24 inserted therein.

For producing the hinge 10, the extruded profiles 14 are at first extruded as endless material. Since the extruded profiles have identical (mirror-symmetric) profile shapes, only a single extrusion die is needed.

Subsequently, the cutouts 22 are milled in the projecting profile portions 20. The connection profiles 26 may also be formed of endless extruded material and may then be cut to a suitable length. Then, in the final assembling step, the rod-like hinge axles 24 only need to be inserted into the passages that are provided for this purpose in the extruded profiles and the connection profiles.

The hinge and their profile members, respectively, may be cut to any desired length and may thereby be adapted to different dimensions of the plates 12. It is an essential advantage of the hinge that, in the position shown in FIG. 1, in which the top sides of the plates 12 are arranged in a common plane, no fastening means such as screws or the like are visible and the hinge is accommodated in a relatively narrow gap between the two plates 12 and does practically not project upwards beyond the top side of the plates 12. Yet, in spite of its inconspicuous design, the hinge has a high stability and functional reliability.

What is claimed is:

1. A 180°-hinge for plate-shaped furniture parts comprising:
two mirror-symmetric extruded profiles, each of which forms one of an L- and U-shaped seat for an edge of one of two furniture parts,
on a side opposite to the seats, a projecting profile portion which is interrupted by cutouts and including a passage,
continuous hinge axles, and
connection profiles which engage in the cutouts and each of which forms two parallel passages for the hinge axles and is pivotable relative to each of the extruded profiles by an angle of at least 90° about the corresponding hinge axle.

2. The hinge according to claim 1, wherein the seats are U-shaped, and two parallel legs of each seat have different lengths.

3. The hinge according to claim 2, wherein the projecting profile portions and shorter legs of the U-shaped seats are flush with one another at an outer surface of the extruded profile.

4. The hinge according to claim 1, wherein the connection profiles form ribs which, together with stops formed at the extruded profiles, limit a pivotal range of the hinge to 180°.
